(19) United States
(12) Patent Application Publication
(10) Pub. No.: US 2023/0413357 A1
(43) Pub. Date: Dec. 21, 2023

(54) COMMUNICATION METHOD, AERIAL VEHICLE, AND USER DEVICE

(71) Applicant: SZ DJI TECHNOLOGY CO., LTD., Shenzhen (CN)

(72) Inventors: Ning MA, Shenzhen (CN); Xiaojun YIN, Shenzhen (CN); Ying CHEN, Shenzhen (CN)

(21) Appl. No.: 18/459,704

(22) Filed: Sep. 1, 2023

Related U.S. Application Data
(63) Continuation of application No. PCT/CN2021/079106, filed on Mar. 4, 2021.

(51) Int. Cl. H04W 76/15; H04W 72/21; H04W 72/1273

(52) U.S. Cl. CPC H04W 76/15; H04W 72/21; H04W 72/1273

(57) ABSTRACT

A communication method includes obtaining downlink transmission data of an aerial vehicle that includes a communication module based on which the aerial vehicle establishes a first communication link not adopting a cellular network communication protocol and a second communication link adopting the cellular network communication protocol with a terminal device, sending the downlink transmission data to the terminal device based on the first communication link, determining a target data receiving mode from a first data receiving mode for receiving uplink transmission data sent by the terminal device based on the first communication link and a second data receiving mode for receiving the uplink transmission data based on the first communication link and the second communication link, and controlling the communication module to work in the target data receiving mode. The uplink transmission data includes at least one of feedback data or control data.

### CROSS-REFERENCE TO RELATED APPLICATION

This application is a continuation of International Application No. PCT/CN2021/079106, filed Mar. 4, 2021, the entire content of which is incorporated herein by reference.

### TECHNICAL FIELD

The present disclosure relates to the field of communication technologies and, more particularly, to a communication method, an aerial vehicle, and a terminal device (user device).

### BACKGROUND

When an aerial vehicle is flying in a field, it uses the industrial scientific medical (ISM) frequency band and is able to achieve high-definition digital image transmission of more than 10 km in a scene without interference or occlusion. However, the aerial vehicle operating in the ISM frequency band is susceptible to interference, especially interference to a receiving end of the aerial vehicle. This is because when the aerial vehicle is moving fast and close to an interference source (such as a building), the interference source causes strong interference to the receiving end of the aerial vehicle, thus affecting the receiving performance of the aerial vehicle.

Therefore, how to improve the receiving performance of the aerial vehicle is still one of the problems to be solved.

### SUMMARY

In accordance with the disclosure, there is provided a communication method including obtaining downlink transmission data of an aerial vehicle that includes a communication module based on which the aerial vehicle establishes at least two communication links with a terminal device. The at least two communication links includes a first communication link not adopting a cellular network communication protocol and a second communication link adopting the cellular network communication protocol. The method further includes sending the downlink transmission data to the terminal device based on the first communication link, determining a target data receiving mode from a plurality of data receiving modes that include a first data receiving mode for receiving uplink transmission data sent by the terminal device based on the first communication link and a second data receiving mode for receiving the uplink transmission data based on the first communication link and the second communication link, and controlling the communication module to work in the target data receiving mode to receive the uplink transmission data. The uplink transmission data includes at least one of feedback data in response to the downlink transmission data or control data for controlling the aerial vehicle.

Also in accordance with the disclosure, there is provided another communication method including obtaining collected data collected by an aerial vehicle. The aerial vehicle is configured to communicate with a terminal device based on a first communication module not adopting a cellular network communication protocol and a second communication module adopting the cellular network communication protocol. The method further includes outputting the collected data to the first communication module such that the first communication module processes the collected data to obtain first communication data and send the first communication data to the terminal device, and in response to the first communication module and the second communication module being turned on, receiving second communication data based on the first communication module and receiving third communication data based on the second communication module. The second communication data and the third communication data are obtained and sent by the terminal device according to target data, and the target data is control data of the terminal device for controlling the aerial vehicle.

Also in accordance with the disclosure, there is provided an aerial vehicle including a communication module, a power assembly, a memory, and a controller. The aerial vehicle establishes at least two communication links with a terminal device based on the communication module. The at least two communication links include a first communication link not using a cellular network communication protocol and a second communication link adopting the cellular network communication protocol. The power assembly is configured to drive the aerial vehicle to move. The memory stores a computer program. The controller is configured to execute the computer program to obtain downlink transmission data of the aerial vehicle, send the downlink transmission data to the terminal device based on the first communication link device, determine a target data reception mode from a plurality of data reception modes that include a first data receiving mode for receiving uplink transmission data sent by the terminal device based on the first communication link and a second data receiving mode for receiving the uplink transmission data based on the first communication link and the second communication link, and control the communication module to work in the target data receiving mode to receive the uplink transmission data. The uplink transmission data includes at least one of feedback data of the terminal device in response to the downlink transmission data or control data for controlling the aerial vehicle.

### BRIEF DESCRIPTION OF THE DRAWINGS

FIG. 1 is a schematic diagram of a communication system consistent with the present disclosure.

FIG. 2 is a schematic diagram of another communication system consistent with the present disclosure.

FIG. 3 is a flow chart of a communication method consistent with the present disclosure.

FIG. 4 is a flow chart of another communication method consistent with the present disclosure.

FIG. 5 is a flow chart of another communication method consistent with the present disclosure.

FIG. 6 is a schematic structural diagram of an aerial vehicle are folded consistent with the present disclosure.

FIG. 7 is a schematic structural diagram of a terminal device consistent with the present disclosure.

FIG. 8 is a schematic structural diagram of a communication device consistent with the present disclosure.

### DETAILED DESCRIPTION OF THE EMBODIMENTS

The technical solutions of the present disclosure will be described below in conjunction with the drawings in the embodiments of the present disclosure. Obviously, the described embodiments are just some of the embodiments of the present disclosure, but not all of the embodiments. Based on the embodiments in this disclosure, all other embodiments obtained by those of ordinary skill in the art without creative work shall fall within the scope of this disclosure.

The flow charts shown in the drawings are just illustrations, and do not necessarily include all contents and operations/steps, nor must they be performed in the order described. For example, some operations/steps can be decomposed, combined or partly combined, so the actual order of execution may be changed according to the actual situation.

The embodiments of the present disclosure will be described below in conjunction with the drawings in the embodiments of the present disclosure. In the case of no conflict, the following embodiments and features in the embodiments may be combined with each other.

To better describe the communication method, the aerial vehicle, and the terminal device provided by the present disclosure, a structure of a communication system consistent with the present disclosure will be presented first.

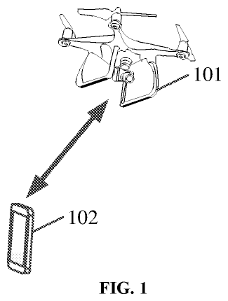

FIG. 1 is a structure of a communication system provided by one embodiment of the present disclosure. As shown in FIG. 1, the communication system includes an aerial vehicle 101 and a terminal device 102 (also referred to as a “user device”). For description purposes only, the present embodiment with one terminal device is used as an example to illustrate the present disclosure, and does not limit the scope of the present disclosure. In various embodiments, the number of terminal devices is not limited. Also, the embodiment shown in FIG. 1 where one aerial vehicle 101 and one terminal device 102 communicate with each other and the terminal device 102 is a mobile phone, is used as an example for description only, and does not limit the scope of the present disclosure. In various embodiments, the terminal device may be a remote control device connected to the aerial vehicle, such as a mobile phone, a tablet, a computer device connected to the aerial vehicle, and so on.

Some concepts related to the present disclosure will be described first.

The first communication link refers to a communication link that does not use a cellular network communication protocol. For example, the first communication link may be a private communication link, and the private communication link refers to a communication link used by the aerial vehicle to communicate with the terminal device based on a point-to-point topology when the aerial vehicle operates in the industrial scientific medical (ISM) frequency band. The aerial vehicle may use the private communication link to communicate with the terminal device for free, and the image transmission delay is low when the aerial vehicle uses the private communication link to communicate with the terminal device.

The second communication link refers to a communication link using a cellular network communication protocol, that is, a public network communication link. The public network communication link refers to a communication link used by the aerial vehicle to communicate with the terminal device through public network communication. Public network communication refers to the current mobile network communication, such as the fourth-generation mobile communication network (4th-Generation, 4G) and the fifth-generation mobile communication network (5th-Generation, 5G). The public network communication adopts cellular communication technology. Unlike the private communication mode, the aerial vehicle cannot directly communicate with the terminal device. The aerial vehicle needs to communicate with a base station first, and the base station communicates through the inter-station interface or the core network.

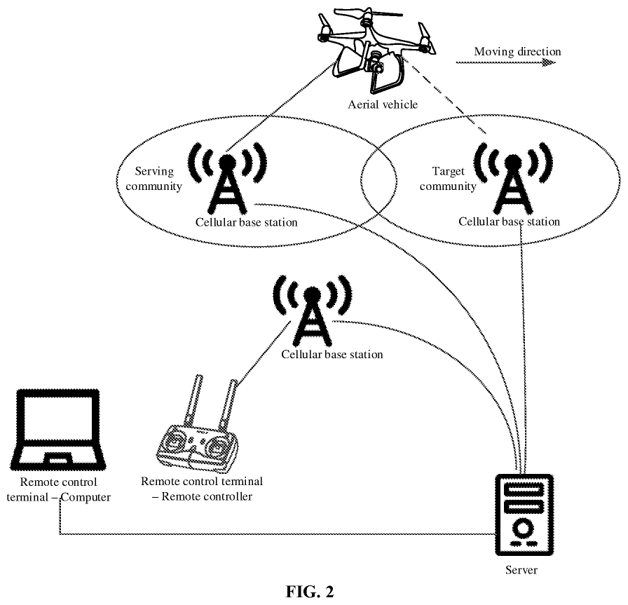

When the cellular network communication protocol is used to communicate between the aerial vehicle and the terminal device, the corresponding communication system is shown in FIG. 2. The communication system in FIG. 2 includes an aerial vehicle, a terminal base station, and a terminal device. The terminal device may be a remote control terminal-a remote controller, a remote control terminal-a computer, etc. shown in FIG. 2. The remote controller may provide real-time manual remote control of the flight of the aerial vehicle, and the computer may download a route to the aerial vehicle to complete automatic flight. It can be seen from the communication system shown in FIG. 2 that the communication between the aerial vehicle and the terminal device is performed through a high-terminal base station.

The first communication module is a communication module used by the aerial vehicle to communicate with the terminal device when the aerial vehicle does not adopt the cellular network communication protocol. The second communication module is a communication module used by the aerial vehicle to communicate with the terminal device when the aerial vehicle adopts the cellular network communication protocol. The third communication module is a communication module used by the terminal device to communicate with the aerial vehicle when the terminal device does not adopt the cellular network communication protocol. The fourth communication module is a communication module used by the terminal device to communicate with the aerial vehicle when the terminal device adopts the cellular network communication protocol. That is, the third communication module corresponds to the first communication module, both of which are corresponding communication modules when the cellular network communication protocol is not adopted. The fourth communication module corresponds to the second communication module, both of which are corresponding communication modules when the cellular network communication protocol is adopted.

The uplink refers to the link in which the terminal device sends and the aerial vehicle receives. The downlink refers to the link in which the aerial vehicle sends and the terminal device receives. The uplink is generally used to transmit the control information of the aerial vehicle and the information mounted on the aerial vehicle, such as the control information stick volume of the aerial vehicle or the control information of a camera mounted on the aerial vehicle. The downlink is mainly used to transmit image transmission data in the first person view (FPV), media file download data, or status information of each module of the aerial vehicle. In addition, the volume of downlink data transmitted from the aerial vehicle to the terminal device is more than 100 times of the volume of uplink data transmitted from the terminal device to the aerial vehicle, that is, the volume of downlink data is much larger than the volume of uplink data.

When the aerial vehicle operates in the ISM frequency band, its receiving end is susceptible to interference from interference sources, resulting in poor receiving performance at the receiving end of the aerial vehicle. In existing technologies, to solve the problem of receiving performance at the receiving end of the aerial vehicle, the aerial vehicle uses public network communication to communicate with the terminal device. This is because the public network communication uses a dedicated frequency band, which can prevent the aerial vehicle from being interfered by external devices. However, when the aerial vehicle communicates with the terminal device using the public network, two wireless communications need to be performed, which results in a relatively long time delay during data transmission. Under the actual network test, the screen-to-screen delay in the 4G network test can be around 300 ms, while the screen-to-screen delay under the 5G network can be within 100 ms. When the aerial vehicle transmits image transmission data through the public network communication, the delay generally exceeds 300 ms, and usually is about 500 ms, that is, there is a relatively high delay. Further, since the public network communication is not free and the public network communication requires two wireless communications, the overhead of the aerial vehicle communication using the public network communication is also relatively high. Therefore, the communication between the aerial vehicle and the terminal device using the public network communication mode cannot solve the above problems well.

The present disclosure provides a communication method to at least partially solve the above problems. The communication method may be applied to an aerial vehicle, and the aerial vehicle may include a communication module. The aerial vehicle may establish at least two communication links with a terminal device based on the communication module, and the at least two communication links may include a first communication link and a second communication link. The first communication link may not use a cellular network communication protocol, and the second communication protocol may use the cellular network communication protocol. In this method, the aerial vehicle may obtain downlink transmission data of the aerial vehicle, and send the downlink transmission data to the terminal device based on the first communication link. Subsequently, a target data receiving mode may be determined among a plurality of data receiving modes, and the communication module may be controlled to work in the target data receiving mode to receive the uplink transmission data sent by the terminal device. The plurality of data receiving modes may include a first data receiving mode and a second data receiving mode. The first data receiving mode may receive the uplink transmission data sent by the terminal device based on the first communication link, and the second data receiving mode may receive the uplink transmission data sent by the terminal device based on the first communication link and the second communication link. The uplink transmission data may include feedback data of the terminal device corresponding to the downlink transmission data and/or control data from the terminal device to the aerial vehicle.

In the present disclosure, the aerial vehicle may transmit the downlink data to the terminal device through the first communication link that does not use the cellular communication protocol. Since the volume of the downlink data is relatively large, the aerial vehicle may be able to transmit the downlink data for free on the first communication link, to save the cost of the system. Further, the aerial vehicle may control the communication module to work in the target data receiving mode to receive the uplink transmission data sent by the terminal device. The target data receiving mode may receive the uplink transmission data sent by the terminal device based on the first communication link, or receive the uplink transmission data sent by the terminal device based on the first communication link and the second communication link. The aerial vehicle may receive the uplink transmission data based on the first communication link for free. When the aerial vehicle receives the uplink transmission data based on the second communication link, the interference at the receiving end of the aerial vehicle may be reduced. Therefore, the receiving performance of the receiving end of the aerial vehicle may be improved while ensuring that the tariff of the terminal device is low at the same time.

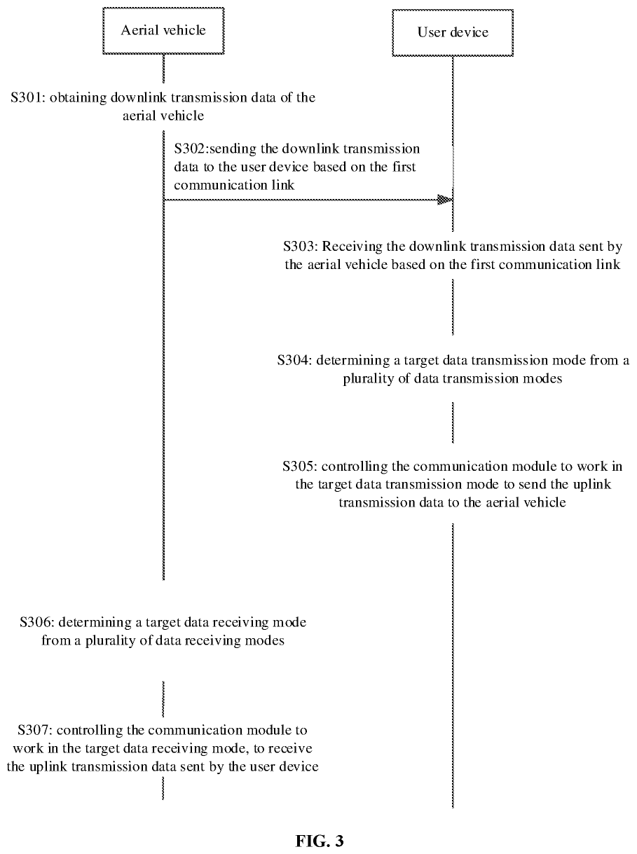

FIG. 3 is a flow chart of a communication method applied to the aerial vehicle and the terminal device provided by one embodiment of the present disclosure. The aerial vehicle and the terminal device may include communication modules, and the aerial vehicle may be able to establish at least two communication links with the terminal device based on the communication modules. The at least two communication links may include a first communication link and a second communication link. The communication method includes S301 to S307 as shown in FIG. 3.

At S301, the aerial vehicle obtains downlink transmission data of the aerial vehicle.

In one embodiment, the downlink transmission data may include one or more of data collected by the aerial vehicle or downlink transmission data of other aerial vehicles forwarded by the aerial vehicle. The data collected by the aerial vehicle may be image data, video data collected by the aerial vehicle, or data collected to represent status information of other communication modules in the aerial vehicle. Further, when the aerial vehicle is a relay node of other aerial vehicles and is used to forward data for other aerial vehicles, the downlink transmission data may include the downlink transmission data of other aerial vehicles to be forwarded by the aerial vehicle.

At S302, the aerial vehicle sends the downlink transmission data to the terminal device based on the first communication link.

At S303, the terminal device receives the downlink transmission data sent by the aerial vehicle based on the first communication link.

Because of the large volume of the downlink transmission data, the aerial vehicle may perform downlink communication with the terminal device based on the free first communication link that does not use the cellular network communication protocol, to realize the transmission of the downlink transmission data. The system communication cost may be reduced.

At S304, the terminal device determines a target data transmission mode from a plurality of data transmission modes. The plurality of data transmission modes includes a first data transmission mode and a second data transmission mode. The first data transmission mode sends the uplink transmission data to the aerial vehicle based on the first communication link, and the second data transmission mode sends the uplink transmission data to the aerial vehicle based on the first communication link and the second communication link.

The first communication link and the second communication link may be pre-established communication links between the terminal device and the aerial vehicle, and the first communication link and the second communication link may be established at the same time or at different times, which is not limited in the present disclosure.

In one embodiment, the plurality of data transmission modes may also include a third data transmission mode, and the third data transmission mode may transmit the uplink transmission data to the aerial vehicle based on the second communication link. That is, the terminal device may also be able to send the uplink transmission data to the aerial vehicle based on the second communication link only, thereby reducing interference at the receiving end of the aerial vehicle.

In one embodiment, in the second data transmission mode, the enabling duration of the second communication link may be longer than the enabling duration of the first communication link. That is, when the terminal device sends the uplink transmission data to the aerial vehicle based on the second data transmission mode, the duration for the terminal device to send the uplink transmission data to the aerial vehicle based on the second communication link may be longer than the duration for the terminal device to send uplink transmission data to the aerial vehicle based on the first communication link. Therefore, the receiving performance of the aerial vehicle receiving end may be improved when the data volume of the uplink transmission data is small.

In another embodiment, in the second data transmission mode, the second communication link may be kept enabled for a long time, and the first communication link may be enabled periodically. That is to, when the terminal device sends the uplink transmission data to the aerial vehicle based on the second data transmission mode, the terminal device may always send the uplink transmission data to the aerial vehicle based on the second communication link, and periodically send the uplink transmission data to the aerial vehicle based on the first communication link. Therefore, when the volume of the uplink transmission data is large, the terminal device may be able to periodically send the uplink transmission data to the aerial vehicle based on the first communication link, thereby reducing the communication cost of the system.

In one embodiment, the terminal device may be able to also obtain the communication quality of the first communication link, such that the aerial vehicle may be able to determine the target data transmission mode from the plurality of data transmission modes. The method may include: based on the communication quality of the first communication link, determining the target data transmission mode from the plurality of data transmission modes, such that the terminal device determines the target data transmission mode for sending the uplink transmission data to the aerial vehicle according to the communication quality of the first communication link.

In an embodiment, the terminal device may obtain the communication quality of the first communication link by: determining the communication quality of the first communication link based on feedback data by the terminal device corresponding to the downlink transmission data sent by the aerial vehicle. That is, when the terminal device is not working on the first communication link, the terminal device may also obtain the communication quality of the first communication link through the feedback data for downlink transmission data.

In one embodiment, the terminal device may determine the target data transmission mode from the plurality of data transmission modes by: when the communication module works in the first data transmission mode and the communication quality of the first communication link does not meet the preset communication quality condition, switching the working mode of the communication module from the first data transmission mode to the second data transmission mode or the third data transmission mode. That is, the terminal device may decide whether to switch the first data transmission mode in which the communication module is currently working to another data transmission mode according to the communication quality of the first communication link.

In another embodiment, when the data sent by the terminal device to the aerial vehicle is the control data and after the target data transmission mode is determined, a data receiving mode selection instruction for the aerial vehicle may be also sent to the aerial vehicle, and the data receiving mode selection instruction may be used to instruct the aerial vehicle to work in the target data receiving mode. The data receiving mode selection instruction may be determined according to the target data transmission mode. For example, when the target data transmission mode determined by the terminal device is the first data transmission mode, the data receiving mode selection instruction sent by the terminal device to the aerial vehicle may be used to instruct the aerial vehicle to work in the first data receiving mode, such that the aerial vehicle adopts the data receiving mode corresponding to the data transmission mode of the terminal device, to receive the uplink transmission data sent by the terminal device. In this embodiment, the terminal device may directly instruct the aerial vehicle to adopt the data receiving mode of the control data and the aerial vehicle may not need to determine the data receiving mode of the control data by itself, thereby reducing the complexity of the aerial vehicle.

At S305, the terminal device controls the communication module to work in the target data transmission mode to send the uplink transmission data to the aerial vehicle. The uplink transmission data may include the feedback data of the terminal device corresponding to the downlink transmission data and/or the control data of the terminal device to the aerial vehicle.

At S306, the aerial vehicle determines the target data receiving mode from a plurality of data receiving modes. The plurality of data receiving modes may include a first data receiving mode and a second data receiving mode. The first data receiving mode may receive the uplink transmission data sent by the terminal device based on the first communication link, and the second data receiving mode may receive the uplink transmission data sent by the terminal device based on the first communication link and the second communication link.

In one embodiment, the plurality of data receiving modes may further include a third data receiving mode, and the third data receiving mode may receive the uplink transmission data sent by the terminal device based on the second communication link. That is, in the third data receiving mode, the aerial vehicle may be able to receive the uplink transmission data sent by the terminal device only based on the second communication link, thereby reducing interference to the receiving end of the aerial vehicle and improving the receiving performance of the aerial vehicle.

In one embodiment, in the second data receiving mode, the enabling duration of the second communication link may be longer than the enabling duration of the first communication link. That is, the duration for the aerial vehicle to receive the uplink transmission data based on the second communication link may be longer than the duration for the aerial vehicle to receive uplink transmission data based on the first communication link, thereby minimizing interference to the receiving end of the aerial vehicle and improving the receiving performance of the receiving end of the aerial vehicle.

In another embodiment, in the second data receiving mode, the second communication link may be kept enabled for a long time, and the first communication link may be enabled periodically. That is, while the aerial vehicle receives the uplink transmission data based on the second communication link for a long time, the aerial vehicle may periodically use the first communication link to receive the uplink transmission data, thereby reducing interference to the receiving end of the aerial vehicle and reducing the system communication cost when the volume of the uplink transmission data is large.

In one embodiment, the aerial vehicle may also obtain the communication quality of the first communication link, such that the aerial vehicle may be able to determine the target data receiving mode from the plurality of data receiving modes. The method may include: based on the communication quality of the first communication link, determining the target data receiving mode from the plurality of data receiving modes. That is, the aerial vehicle may determine a receiving mode for receiving the data sent by the terminal device based on the communication quality of the first communication link.

For example, when the communication quality of the first communication link is lower than a first preset condition, the aerial vehicle may determine that the target data receiving mode is the second data receiving mode. When the communication quality of the first communication link is larger than a second preset condition, the aerial vehicle may determine that the target data receiving mode is the first data receiving mode. In the present embodiment, when the communication quality of the first communication link is good, the aerial vehicle may only use the first data receiving mode to receive the uplink transmission data sent by the user, to reduce the communication cost of the system. When the communication quality of the first communication link is poor, to improve the receiving performance of the receiving end of the aerial vehicle, the aerial vehicle may adopt the second data receiving mode to receive the uplink transmission data sent by the user.

In one embodiment, the aerial vehicle may obtain the communication quality of the first communication link by: determining the communication quality of the first communication link based on the received feedback data corresponding to the downlink transmission data from the terminal device. When the feedback data of the terminal device corresponding to the downlink transmission data is less, the communication quality of the first communication link may be lower.

In the embodiments of the present disclosure, determination of the target data receiving mode by the aerial vehicle may be understood as switching, enabling or other meanings. For example, in one embodiment, the aerial vehicle may determine the target data receiving mode from the plurality of data receiving modes, by: when the communication module works in the first data receiving mode and the communication quality of the first communication link does not meet the preset communication quality condition, switching the working mode of the communication module from the first data receiving mode to the second data receiving mode or the third data receiving mode. That is, determining the target data receiving mode by the aerial vehicle may also be understood as switching the current data receiving mode to another data receiving mode by the aerial vehicle, such that the aerial vehicle adopts a suitable data receiving mode to receive the uplink transmission data.

At S307, the aerial vehicle controls the communication module to work in the target data receiving mode for receiving the uplink transmission data sent by the terminal device.

In one embodiment, the aerial vehicle may receive the control data of the aerial vehicle sent by the terminal device by: receiving the data receiving mode selection instruction which is used to instruct the aerial vehicle to work in the target data receiving mode from the terminal device. The aerial vehicle may determine the target data receiving mode from the plurality of data receiving modes by: determining the target data receiving mode from the plurality of data receiving modes based on the data receiving mode selection instruction. That is, when the uplink transmission data sent by the terminal device is the control data for the aerial vehicle, the user may indicate the target data receiving mode to the aerial vehicle through the terminal device, such that the aerial vehicle adopts the target data receiving mode indicated by the terminal device to receive the uplink transmission data.

In the present embodiment, because of the large volume of the downlink transmission data, the aerial vehicle and the terminal device may transmit the downlink transmission data based on the first communication link that does not use the cellular network communication protocol, thereby reducing the communication cost of the system. Further, the terminal device and the aerial vehicle may determine whether to use the first communication link to transmit the uplink transmission data or to use the first communication link and the second communication link to transmit the uplink transmission data according to the volume of uplink transmission data and/or the communication quality of the first communication link, thereby reducing the interference to the receiving end of the aerial vehicle and improving the receiving performance of the receiving end of the aerial vehicle, while reducing the communication cost of the system.

Another embodiment shown in FIG. 4 provides another communication method between the aerial vehicle and the use device. In the present embodiment shown in FIG. 4, the aerial vehicle transmits data with the terminal device based on the first communication module and the second communication module, and the terminal device transmits data with the aerial vehicle based on the third communication module and the fourth communication module. The first communication module and the third communication module do not use the cellular network communication protocol, while the second communication module and the fourth communication module adopt the cellular network communication protocol. The method includes S401 to S405.

At S401, the aerial vehicle obtains the data collected by the aerial vehicle, and outputs the collected data to the first communication module. The collected data is processed through the first communication module and first communication data obtained by the procession is sent to the terminal device. The data collected by the aerial vehicle may refer to S301, and will not be repeated here.

After the aerial vehicle obtains the collected data, the aerial vehicle may process the collected data through the first communication module that does not use the cellular network communication protocol, and then send the first communication data processed by the first communication module through the first communication module to the terminal device. That is, the aerial vehicle may perform the downlink communication with the terminal device through the first communication module that does not use the cellular network communication protocol. Since the data volume of the downlink transmission data is relatively large and the communication link corresponding to the first communication module that does not use the cellular network communication protocol is free, the present embodiment may ensure the reliable transmission of the downlink transmission data and reduce the communication cost of the system.

At S402, the terminal device receives the first communication data sent by the aerial vehicle through the third communication module. The third communication module is a communication module corresponding to the first communication module. That is, when the aerial vehicle sends the first communication data to the terminal device through the first communication module at S401, the terminal device may receive the first communication data through the third communication module.

At S403, the terminal device obtains the target data. When the aerial vehicle currently turns on the first communication module and the second communication module, the target data is processed by the third communication module to obtain second communication data, and the target data is processed by the fourth communication module to obtain third communication data. The target data is control data of the aerial vehicle by the terminal device.

The terminal device may determine that the aerial vehicle currently turns on the first communication module and the second communication module through various implementation manners. For example, in one embodiment, the terminal device may determine the currently activated communication modules of the aerial vehicle through interaction with the aerial vehicle. That is, the terminal device may request the communication modules activated by the aerial vehicle to the aerial vehicle, such that the aerial vehicle notifies the terminal device of the currently activated communication modules. For example, the terminal device may send a test signal to the aerial vehicle through the public communication link, and may determine that the aerial vehicle currently turns on the first communication module and the second communication module when the terminal device receives a response to the test signal.

In another embodiment, the terminal device may determine the currently activated communication modules of the aerial vehicle according to a pre-agreed rule with the aerial vehicle. For example, the terminal device may determine whether the fourth communication module is turned on. When the fourth communication module is turned on, the terminal device may determine as default that the first communication module and the second communication module are currently turned on by the aerial vehicle.

After the terminal device obtains the target data and determines that the aerial vehicle has currently turned on the first communication module and the second communication module, the target data may be processed by the third communication module to obtain the second communication data, and the target data may be processed by the third communication module to obtain the third communication data, such that the terminal device executes S403. That is, the terminal device may send the second communication data to the aerial vehicle through the third communication module, and send the third communication data to the aerial vehicle through the fourth communication module. In this embodiment, the terminal device may perform the uplink communication with the aerial vehicle through the first communication module and the second communication module, ensuring the reliability of the uplink data, reducing the interference to the receiving end of the aerial vehicle, and improving the receiving performance of the receiving end of the aerial vehicle.

In one embodiment, the terminal device may process the target data through the third communication module to obtain the second communication data and process the target data through the fourth communication module to obtain the third communication data, by that: the terminal device may use the communication protocol of the third communication module to process the target data and obtain the second communication data; the intermediate data obtained by the application layer of the communication protocol adopted by the third communication module according to the target data may be transmitted to the application layer of the cellular network communication protocol adopted by the fourth communication module; and then the intermediate data may be processed based on the cellular network communication protocol adopted by the fourth communication module to obtain the third communication data.

That is, the second communication data may be obtained by the terminal device processing the target data through the communication protocol adopted by the third communication module, and the third communication data may be obtained through the intermediate data after the terminal device processes the target data through the cellular network communication protocol adopted by the fourth communication module. Therefore, both the second communication data and the third communication data sent by the terminal device to the aerial vehicle may be obtained based on the target data, and may be transmitted to the aerial vehicle through different communication modules. In this embodiment, the terminal device may send the second communication data and the third communication data obtained based on the target data to the aerial vehicle through the third communication module and the fourth communication module respectively, to ensure the reliability of the target data and ensure that the aerial vehicle is able to receive one communication data obtained based on the target data.

In one embodiment, after the terminal device obtains the target data, the terminal device may also determine the type of the target data. When the type of the target data is a predefined type, processing the target data through the fourth communication module to obtain the third communication data may be triggered to be executed. The predefined type of data may be understood as data whose data volume is smaller than a first preset threshold, or the predefined type of data may be data whose reliability is greater than a second preset threshold, etc. That is, the terminal device may only send some data with a small volume or data with low reliability to the aerial vehicle through the third communication module and the fourth communication module, to ensure the reliability of such data.

In one embodiment, during the communication process between the terminal device and the aerial vehicle based on the third communication module, first interference level information of the first communication link corresponding to the third communication module may be obtained. When the first interference level information of the first communication link corresponding to the third communication module satisfies a first communication condition, it may be determined that the aerial vehicle already turned on the second communication module.

The first communication condition may be a communication condition preset by the aerial vehicle. For example, in one embodiment, the first communication condition may be that the interference level value in the first interference level information is larger than a first preset threshold value. The interference level value may be obtained by smoothing a plurality of interference level values of the first communication link obtained in a preset period by the aerial vehicle.

That is, during the process of the terminal device communicating with the aerial vehicle based on the third communication module, it may be determined whether the aerial vehicle is in the state where the second communication module is turned on according to the first interference level corresponding to the first communication link, such that it is determined whether the terminal device is able to perform the uplink communication with the aerial vehicle through the fourth communication module.

In another embodiment, after the terminal device determines that the aerial vehicle is in the second communication mode, the terminal device may also obtain second interference level information of the first communication link corresponding to the third communication module. When the second interference level information satisfies the default link communication condition, it may be determined that the aerial vehicle has turned on the first communication module.

That is, during the communication process between the terminal device and the aerial vehicle based on the fourth communication module, it may be also determined whether the aerial vehicle switches from the second communication module to the first communication module based on the second interference level of the first communication mode, such that the terminal device is able to switch from the fourth communication module to the third communication module to perform the uplink communication with the aerial vehicle. Therefore, the communication cost of the system may be reduced.

In yet another embodiment, when the terminal device detects that the aerial vehicle is in a low battery state and the obtained second interference level information of the first communication link corresponding to the third communication module satisfies the second communication condition, it may be determined that the aerial vehicle has turned on the first communication module. That is, when the aerial vehicle is in the low battery state and the second interference level of the first communication link is larger than the third preset threshold, the terminal device may determine that the aerial vehicle has turned on the first communication module, to perform the uplink communication with the aerial vehicle through the fourth communication module. The interference to the receiving end of the aerial vehicle may be reduced when the interference level of the aerial vehicle is high, and may also save the power of the aerial vehicle.

In yet another embodiment, after the terminal device confirms that the aerial vehicle is in the second communication mode, it may also detect the third interference level information of the first communication link with the terminal device established through the third communication module at regular intervals based on the connection test. When the third interference level information satisfies the third communication condition, it may be determined that the aerial vehicle has turned on the first communication module and the second communication module.

In one embodiment, the terminal device may detect the third interference level information of the first communication link with the terminal device established through the third communication module at intervals based on the connection test rule, by that: the terminal device may detect a plurality of interference level values of the first communication link with the terminal device established by the third communication module periodically based on the periodic time information indicated by the connection test rule; and the third interference level information may be obtained according to the plurality of interference level values.

The present embodiment may allow the terminal device to detect the third interference level of the first communication link at intervals. When the third interference level information meets the third communication condition, it may be determined that the aerial vehicle has turned on the first communication module and the second communication module, such that the terminal device is able to perform the uplink communication with the aerial vehicle through the third communication module and the fourth communication module. The interference to the receiving end of the aerial vehicle may be reduced and the receiving performance of the receiving end of the aerial vehicle may be improved while ensuring the reliability of the uplink data.

At S404, the terminal device sends the second communication data through the third communication module, and sends the third communication data through the fourth communication module.

At S405, if the first communication module and the second communication module are currently turned on by the aerial vehicle, the second communication data is received based on the first communication module, and the third communication data is received based on the second communication module.

That is, if the aerial vehicle currently turns on the first communication module and the second communication module, the second communication data may be received based on the first communication module not using the cellular network protocol, and the second communication data may be received based on the second communication module using the cellular network protocol. The communication link corresponding to the first communication module that does not adopt the cellular network protocol is free and the communication link corresponding to the second communication module that adopts the cellular network protocol may reduce the interference to the receiving end of the aerial vehicle. Therefore, in the present embodiment, while the communication cost of the system is reduced, the interference to the receiving end of the aerial vehicle may be reduced to improve the receiving performance of the receiving end of the aerial vehicle.

The target data may be the data transmitted in the above-mentioned uplink.

In one embodiment, before the aerial vehicle receives the third data based on the second communication module, the aerial vehicle may also obtain the first interference level information of the first communication link corresponding to the first communication module during the communication process between the aerial vehicle and the terminal device based on the first communication module. If the first interference level information satisfies the first communication condition, the second communication module may be turned on to communicate with the terminal device through the second communication module.

The first communication condition of the aerial vehicle may correspond to the first communication condition of the terminal device. That is, the first communication condition of the aerial vehicle may be the first communication condition of the terminal device, or may be a communication condition that matches the first communication condition of the terminal device but is not identical to the first communication condition of the terminal device.

That is, during the communication process of the aerial vehicle with the terminal device based on the first communication module, the aerial vehicle may obtain the first interference level information of the first communication link. When it is determined that the first interference level information satisfies the first communication condition of the aerial vehicle, the second communication module may be turned on to enable the aerial vehicle to communicate with the terminal device through public network communication. Therefore, when the interference level of the first communication link is high, the aerial vehicle may be able to use the public network communication to communicate with the terminal device, thereby reducing the interference to the receiving end of the aerial vehicle and improving the receiving performance of the receiving end of the aerial vehicle.

In another embodiment, when the aerial vehicle determines that the above-mentioned first interference level satisfies the first communication condition of the aerial vehicle and the first communication module of the aerial vehicle is not turned off after the second communication module is turned on, it may indicate that the aerial vehicle currently has the first communication module and the second communication module turned on. Therefore, the aerial vehicle may be able to receive the second communication data from the terminal device through the first communication module, and receive the third communication data from the terminal device through the second communication module. Therefore, while reducing the interference at the receiving end of the aerial vehicle, the communication cost of the system may also be reduced.

In yet another embodiment, when the aerial vehicle determines that the above-mentioned first interference level satisfies the first communication condition of the aerial vehicle and the first communication module of the aerial vehicle is turned off after the second communication module is turned on, it may indicate that the aerial vehicle is currently only turning on the second communication module. Therefore, the aerial vehicle may be able to receive the third communication data from the terminal device through the second communication module. Therefore, the interference at the receiving end of the aerial vehicle may be reduced significantly to ensure reliable receipt of the second communication data.

In another embodiment, after the second communication module is turned on, the aerial vehicle may also obtain the second interference level of the first communication link corresponding to the first communication module. When the second interference level satisfies the default link communication conditions, the second communication module may be turned off. The default link communication condition may be that the second interference level is lower than a second preset threshold.

In the present embodiment, after the second communication module is turned on, the aerial vehicle may still monitor the second interference level of the first communication link corresponding to the first communication module during communication with the terminal device through the public network communication. When the second interference level is lower than the second preset threshold, the aerial vehicle may turn off the second communication module and switch to the default first communication mode. At this time, the aerial vehicle may only use the first communication module to receive the second communication data from the terminal device. In the present embodiment, the aerial vehicle may continuously monitor the second interference level of the first communication link corresponding to the first communication module, and may close the public network communication in time according to the second interference level to only use the default first communication module to communicate with the terminal device. The problems of high overhead and long delays caused by the aerial vehicle using public network communication for a long time may be avoided.

In yet another embodiment, when the aerial vehicle is in a low battery state and the obtained first interference level information of the first communication link corresponding to the first communication module satisfies the second communication condition, the first communication module may be turned off. The second communication condition may be that the first interference level is larger than a third preset threshold. That is, when the aerial vehicle is in the low battery state and the first interference level satisfies the second communication condition, the first communication module may be turned off, and only the second communication module may be used to communicate with the terminal device, thereby improving the receiving performance of the receiving end of the aerial vehicle.

In another embodiment, after the first communication module is turned off, the aerial vehicle may also turn on the first communication module at regular intervals based on the connection test rule, and detect third interference level information of the first communication link corresponding to the first communication module after the first communication module is turned on. When the third interference level information satisfies the third communication condition, the first communication module may be turned on. The third communication condition may be that the third interference level information is smaller than a fourth preset threshold. That is, after the aerial vehicle turns off the first communication module, it may restart the first communication module continuously according to the third interference level information.

In one embodiment, the aerial vehicle may turn on the first communication module at regular intervals based on the connection test rule and detect the third interference level information of the first communication link corresponding to the first communication module after the first communication module is turned on, by that: the aerial vehicle may periodically turn on the first communication module and establish the first communication link with the terminal device through the first communication module according to the periodic time information indicated by the connection test rules; the aerial vehicle may perform interference evaluation on the first communication link to obtain a plurality of interference level values; and the third interference level information may be obtained according to the plurality of interference level values.

In the present embodiment, the aerial vehicle may switch the communication module between the first communication link and the second communication link to communicate with the terminal device according to the interference level of the first communication link. That is, the aerial vehicle may use the second communication module to communicate with the terminal device when the interference level of the first communication link is relatively large, to reduce the interference to the receiving end of the aerial vehicle and improve the receiving performance of the receiving end of the aerial vehicle. When the interference level is small, the first communication module may be still used to communicate with the terminal device, to reduce the communication cost of the system.

In the present embodiment, the aerial vehicle may perform the downlink communication with the terminal device through the first communication link corresponding to the first communication module. Since the volume of the downlink data is relatively large, the aerial vehicle may be able to transmit the downlink data on the first communication link for free, to reduce the communication cost of the whole system. Further, when the aerial vehicle currently turns on the first communication module and the second communication module, the aerial vehicle may be able to respectively receive the second communication data and the third communication data from the terminal device through the first communication module and the second communication module. The second communication module corresponds to the public network communication mode may reduce the interference to the receiving end of the aerial vehicle. Therefore, the aerial vehicle may use both the first communication module and the second communication module to perform the uplink communication with the terminal device, to improve the receiving performance of the receiving end of the aerial vehicle and also ensure that the communication cost of the terminal device is low.

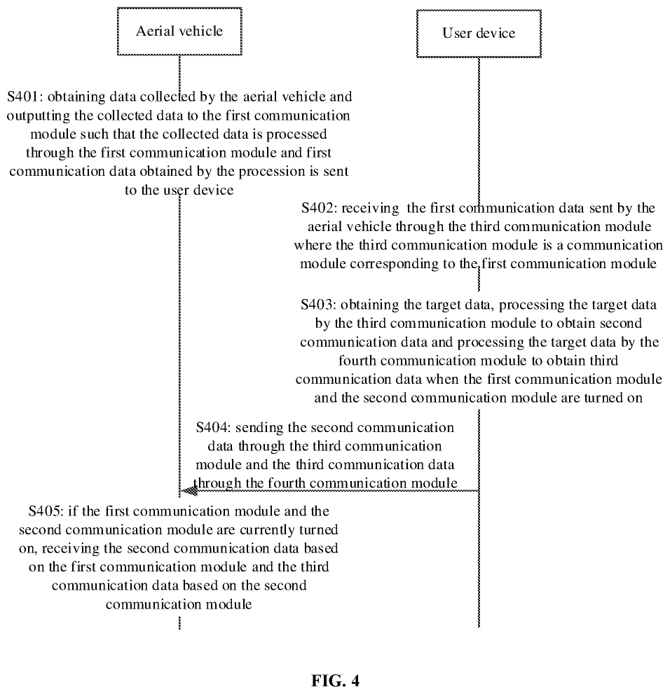

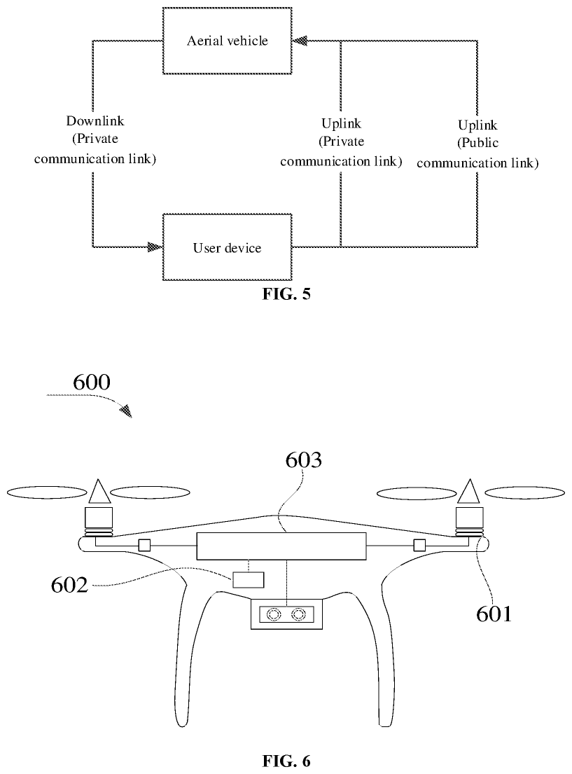

FIG. 5 shows another communication method consistent with the disclosure. As shown in FIG. 5, the aerial vehicle performs the downlink transmission with the terminal device through the private communication link. That is, the downlink transmission data is transmitted to the terminal device through the private communication link. The private communication link refers to the communication link that does not use the cellular network communication protocol, for example, may be a communication link corresponding to ISM. Further, the terminal device performs the uplink communication with the aerial vehicle based on the private communication link and the public network communication link. That is, the terminal device transmits the uplink transmission data to the aerial vehicle based on the private communication link and the public network communication link. The public network communication link may be a communication link that uses the cellular network communication protocol, for example, may be a communication link corresponding to 4G.

When the terminal device performs the uplink communication with the aerial vehicle based on the private communication link and the public network communication link, the private communication link and the public network communication link may work simultaneously or independently. The present disclosure has no limit on this.

In one embodiment, since the terminal device and the aerial vehicle are able to use the private communication link for free, only the private communication link may be in the working state during the uplink communication by default. The private communication link may remain in the working state during the entire uplink communication process. That is, the terminal device may always use the private communication link to perform the uplink communication with the aerial vehicle.

In another embodiment, the above-mentioned private communication link may keep working, and the terminal device may obtain the interference level of the private communication link at the receiving end of the aerial vehicle. When the interference level exceeds a preset value, it may be indicated that the interference at the receiving end of the aerial vehicle is relatively large and the public network communication link may be enabled. That is, the private communication link and the public network communication link may be in working state at the same time, and the terminal device may perform the uplink communication with the aerial vehicle through the private communication link and the public network communication link, thereby reducing the interference to the receiving end of the aerial vehicle and improving the receiving performance of the receiving end of the aerial vehicle

In yet another embodiment, after the above-mentioned private communication link and the public network communication link are enabled at the same time, the terminal device may obtain the interference level at the receiving end of the aerial vehicle. When the smoothed interference level value with a preset period is lower than the preset value, the terminal device may close the public network communication link. At this time, the interference to the receiving end of the aerial vehicle may be relatively small, and the terminal device may only use the private communication link to perform the uplink communication with the terminal device, thereby reducing the communication cost of the system.

In yet another implementation, in a default initial state, only the private communication link may be enabled. When the interference level of the receiving end of the aerial vehicle obtained by the terminal device is larger than a preset value, the terminal device may close the private communication link and open the public network communication link. In this case, the terminal device may only use the public network communication link to perform the uplink communication with the aerial vehicle, to save power consumption of the aerial vehicle.

In yet another embodiment, after the terminal device closes the private communication link and opens the public network communication link, the terminal device may periodically open the private communication link. While the terminal device performs the uplink communication with the aerial vehicle based on the public network communication link, the terminal device may also periodically perform the uplink communication with the aerial vehicle based on the private communication link, to reduce interference at the receiving end of the aerial vehicle and also reduce system communication cost.

In yet another embodiment, after the above-mentioned terminal device opens the public network communication link, the terminal device may continue to obtain the interference level of the receiving end of the aerial vehicle. When the interference level after being smoothed within a certain period is lower than the preset value, the public network communication link may be closed and the private communication link may be open. That is, when the terminal device detects that the interference level at the receiving end of the aerial vehicle is low, the terminal device may only use the private communication link to perform the uplink communication with the aerial vehicle, to reduce the communication cost of the system.

In yet another embodiment, when only the reliability of the uplink communication between the terminal device and the aerial vehicle is considered, the terminal device may always open the private communication link and the public network communication link, such that the terminal device is able to use the private communication link and the public network communication link for a long time to perform the uplink communicates with the aerial vehicle, to ensure reliable transmission of the uplink data.

In one embodiment, when the terminal device uses the public network communication link to perform the uplink communication with the aerial vehicle, related signals of the downlink private communication link may be fed back to the aerial vehicle through the public network communication link, to increase the reliability of signal feedback. For example, the terminal device may feed back signals for a medium access control (MAC) layer or an HE physical (PHY) layer to the aerial vehicle through the public network communication link.

In the present disclosure, the aerial vehicle may perform the downlink communication with the terminal device based on the private communication link to reduce the communication cost of the system, and the terminal device may perform the uplink communication with the aerial vehicle based on the private communication link and the public network communication link to reduce the interference to the receiving end and improve the receiving performance of the receiving end of the aerial vehicle.

The present disclosure also provides an aerial vehicle. In one embodiment, as shown in FIG. 6, the aerial vehicle includes a communication module. The aerial vehicle may establish at least two communication links with the terminal device based on the communication module. The at least two communication links may include a first communication link and a second communication link. The first communication link may not adopt the cellular network communication protocol, and the second communication link may adopt the cellular network communication protocol. The aerial vehicle 600 also includes a power assembly 601, a memory 602, and a controller 603.

The power assembly 601 is used to drive the aerial vehicle to move. The memory 602 is used to store a computer program. The controller 603 is configured to execute the computer program to: obtain the downlink transmission data of the aerial vehicle; send the downlink transmission data to the terminal device based on the first communication link; determine a target data receiving mode from a plurality of data receiving modes including a first data receiving mode and a second data receiving mode; and control the communication module to work in the target data receiving mode, to receive the uplink transmission data sent by the terminal device. The first data receiving mode may receive the uplink transmission data sent by the terminal device based on the first communication link, and the second data receiving mode may receive the uplink transmission data sent by the terminal device based on the first communication link and the second communication link. The uplink transmission data may include feedback data of the terminal device corresponding to the downlink transmission data and/or control data of the aerial vehicle by the terminal device.

In one embodiment, the downlink transmission data may include one or more of the data collected by the aerial vehicle or downlink transmission data of other aerial vehicles forwarded by the aerial vehicle.

In one embodiment, the plurality of data receiving modes may also include a third data receiving mode, and the third data receiving mode may receive the uplink transmission data sent by the terminal device based on the second communication link.

In one embodiment, the aerial vehicle may also include a buffer configured to record the sent downlink transmission data. The data volume of the downlink transmission data that has been sent and is recorded in the buffer when the communication module works in the third data receiving mode may be larger than the data volume of the downlink transmission data that has been sent and is recorded in the buffer when the communication module works in the first data receiving mode or the second data receiving mode.

In one embodiment, when the communication module is working in the third data receiving mode, the data volume of the sent downlink transmission data recorded in the buffer may be determined based on the delay time of the second communication link.

In one embodiment, in the second data receiving mode, the enabling duration of the second communication link may be longer than the enabling duration of the first communication link.

In another embodiment, in the second data receiving mode, the second communication link may be kept enabled for a long time, and the first communication link may be enabled periodically.

In one embodiment, when the controller 603 is configured to receive the aerial vehicle control data sent by the terminal device, the controller 603 may be configured to: receive a data receiving mode selection instruction from the terminal device to the aerial vehicle where the instruction is used to instruct the aerial vehicle to work in the target data receiving mode. When the controller 603 is configured to determine the target data receiving mode from the plurality of data receiving modes, the controller 603 may be configured to: based on the received mode selection instruction, determine the target data receiving mode from the plurality of data receiving modes according to the data receiving mode selection instruction.

In one embodiment, the controller 603 may be further configured to: obtain communication quality of the first communication link. When the controller 603 is configured to determine the target data receiving mode from the plurality of data receiving modes, the controller 603 may be configured to: based on the received mode selection according to the communication quality of the first communication link.

In one embodiment, when the controller 603 is configured to obtain communication quality of the first communication link, the controller 603 may be configured to: determine the communication quality of the first communication link based on the received feedback data of the terminal device on the downlink transmission data.

In one embodiment, when the controller 603 is configured to determine the target data receiving mode from the plurality of data receiving modes, the controller 603 may be configured to: when the communication module is working in the first data receiving mode and the communication quality of the first communication link does not meet the preset communication quality condition, switch the working mode of the communication module from the first data receiving mode to the second data receiving mode or the third data receiving mode.

Another embodiment of the present disclosure also provides another aerial vehicle. The aerial vehicle may transmit data with the terminal device based on a first communication module and a second communication module. The first communication module does not adopt the cellular network communication protocol, and the second communication module adopts the cellular network communication protocol. The aerial vehicle 600 may also include a power assembly 601, a memory 602, and a controller 603.

The power assembly 601 may be used to drive the aerial vehicle to move. The memory 602 may be used to store a computer program. The controller 603 may be configured to execute the computer program to: obtain data collected by the aerial vehicle; send the collected data to the first communication module; process the collected data through the first communication module; and send first communication data obtained by processing to the terminal device.

When the aerial vehicle currently turns on the first communication module and the second communication module, second communication data may be received based on the first communication module, and third communication data may be received based on the second communication module.

Both the second communication data and the third communication data may be obtained and sent by the terminal device according to target data. The target data may be control data of the aerial vehicle by the terminal device.

In one embodiment, before the controller 603 receives the third communication data based on the second communication module, the controller 603 may also be configured to: during the communication process of the aerial vehicle with the terminal device based on the first communication module, obtain the first interference level information of the first communication link corresponding to the first communication module; and, when the first interference level information satisfies the first communication condition, turn on the second communication module such that the aerial vehicle communicates with the terminal device through the second communication module.

In one embodiment, after the controller 603 turns on the second communication module, the controller 603 may also be configured to: obtain the second interference level information of the first communication link corresponding to the first communication module; and, when the second interference level information satisfies the default link communication condition, turn off the second communication module.

In one embodiment, the controller 603 may also be used to: when the aerial vehicle is in a low battery state and the obtained second interference level information of the first communication link corresponding to the first communication module satisfies the second communication condition, turn off the first communication module.

In one embodiment, after the controller 603 turns off the first communication module, the controller 603 may also be configured to: turn on the first communication module at regular intervals based on a connection test rule; detect the third interference level information of the first communication link with the terminal device established by the first communication module after the first communication module is turned on; and, when the third interference level information satisfies the third communication condition, turn on the first communication module.

In one embodiment, when the controller 603 is configured to turn on the first communication module at regular intervals based on the connection test rule and detect the third interference level information of the first communication link with the terminal device established by the first communication module after the first communication module is turned on, the controller 603 may be configured to: based on the periodic time information indicated by the connection test rule, periodically turn on the first communication module and establish the first communication link with the terminal device through the first communication module; and perform interference evaluation on the first communication link to obtain a plurality of interference level values; and obtain the third interference level information according to the plurality of interference level values.

In one embodiment, after the second communication link between the aerial vehicle and the terminal device is established, the controller 603 may increase a receiving buffer, to receive the data received through the first communication link and the second communication module in the increased receiving buffer.

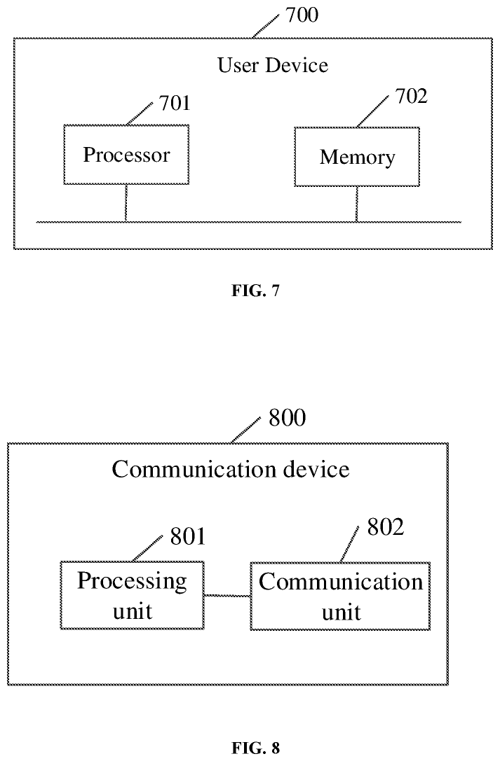

The present disclosure also provides a terminal device. As shown in FIG. 7, in one embodiment, the terminal device 700 may include a processor 701 and a memory 702. The processor 701 and the memory 702 are connected by one or more communication buses.

In one embodiment, the processor 701 may be a central processing unit (CPU). In other embodiments, the processor 701 may also be another general-purpose processor, a digital signal processor (DSP), an application-specific integrated circuits (ASIC), a field-programmable gate array (FPGA) or another programmable logic device, a discrete gate or transistor logic device, a discrete hardware component, etc. A general-purpose processor may be a microprocessor, or any conventional processor, or the like. The processor 701 may be configured to support the terminal device to execute corresponding functions of the terminal device in the methods provided by various embodiments of the present disclosure as shown in FIG. 4 and FIG. 5.

The memory 702 may include a read-only memory and a random-access memory, and may be configured to provide a computer program and data to the processor 701. A portion of memory 702 may also include a non-volatile random access memory.

In one embodiment, the terminal device may include a communication module, and the terminal device may be able to establish at least two communication links with the aerial vehicle based on the communication module. The at least two communication links may include a first communication link and a second communication link. The first communication link does not adopt the cellular network communication protocol, and the second communication link adopts the cellular network communication protocol

When the processor 701 executes the computer program, the processor 701 may be configured to: receive the downlink transmission data sent by the aerial vehicle based on the first communication link; determine the target data transmission mode from the plurality of data transmission modes; and control the communication module to work in the target data transmission mode to send the uplink transmission data to the aerial vehicle.

The plurality of data transmission modes may include the first data transmission mode and the second data transmission mode. The first data transmission mode may send the uplink transmission data to the aerial vehicle based on the first communication link, and the second data transmission mode may send the uplink data to the aerial vehicle based on the first communication link and the second communication link. The uplink transmission data may include the feedback data of the terminal device corresponding to the downlink transmission data and/or the control data of the aerial vehicle by the terminal device.

In one embodiment, the downlink transmission data may include one or more of data collected by the aerial vehicle or the downlink transmission data of other aerial vehicles forwarded by the aerial vehicle.

In one embodiment, the plurality of data transmission modes may also include a third data transmission mode, and the third data transmission mode may send the uplink transmission data to the aerial vehicle by the second communication link.

In one embodiment, in the second data transmission mode, the enabling duration of the second communication link may be longer than the enabling duration of the first communication link.

In another embodiment, in the second data transmission mode, the second communication link may be kept enabled for a long time, and the first communication link may be enabled periodically.

In one embodiment, the processor 701 may be further configured to: send a data receiving mode selection instruction for the aerial vehicle to the aerial vehicle, where the instruction is used to instruct the aerial vehicle to work in the target data receiving mode.

In one embodiment, the processor 701 may be further configured to: obtain the communication quality of the first communication link. Determining the target data transmission mode from the plurality of data transmission modes may include: determining the target data transmission mode among the plurality of data transmission modes based on the communication quality of the first communication link.

In one embodiment, the processor 701 may obtain the communication quality of the first communication link, by: determining the communication quality of the first communication link based on the feedback data of the terminal device corresponding to the downlink transmission data sent by the aerial vehicle.

In one embodiment, the processor 701 may determine the target data transmission mode from the plurality of data transmission modes, by: when the communication module works in the first data transmission mode and the communication quality of the first communication link does not meet the preset communication quality condition, switching the working mode of the communication module from the first data transmission mode to the second data transmission mode or the third data transmission mode.

In another embodiment, the terminal device may transmit data with the aerial vehicle through a third communication module and a fourth communication module. The third communication module does not use a cellular network communication protocol, and the fourth communication module uses a cellular network communication protocol. When the processor 701 executes the computer program, the processor 701 may be configured to: receive the first communication data sent by the aerial vehicle on the third communication module; obtain the target data; when the aerial vehicle currently turns on the first communication module and the second communication module, process the target data through the third communication module to obtain second communication data, and process the target data through the fourth communication module to obtain third communication data; and send the second communication data through the third communication module and send the third communication data through the fourth communication module.

The target data may be the control data of the terminal device to the aerial vehicle.

In one embodiment, when the processor 701 is configured to process the target data through the third communication module to obtain the second communication data and process the target data through the fourth communication module to obtain the third communication data, the process 701 may be configured to: process the target data through the communication protocol adopted by the third communication module to obtain the second communication data; transmit the intermediate data obtained by the application layer of the communication protocol adopted by the third communication module according to the target data to the application layer of the cellular network communication protocol adopted by the fourth communication module; and, based on the cellular network communication protocol adopted by the fourth communication module, process the intermediate data to obtain the third communication data.

In one embodiment, the processor 701 may be further configured to: determine the type of the target data; and, when the type of the target data is a predefined type, trigger execution of processing the target data through the fourth communication module to obtain the third communication data.

In one embodiment, the processor 701 may be further configured to: in the process of the terminal device communicating with the aerial vehicle based on the third communication module, obtain the first interference level information of the first communication link corresponding to the third communication module; and when the first interference level information of the first communication link corresponding to the third communication module satisfies the first communication condition, determine that the aerial vehicle has turned on the second communication module.

In one embodiment, after turning on the fourth communication module, the processor 701 may be further configured to: obtain second interference level information of the first communication link corresponding to the third communication module; and, when the second interference level information satisfies a default link communication condition, determine that the first communication module is turned on by the aerial vehicle.

In one embodiment, the processor 701 may be further configured to: when it is detected that the aerial vehicle is in a low battery state and the obtained second interference level information on the first communication link corresponding to the third communication module satisfies the second communication condition, determine that the second communication module is turned on by the aerial vehicle.

In one embodiment, after turning on the fourth communication module, the processor 701 may be further configured to: detect third interference level information of the first communication link with the terminal device established through the third communication module at regular intervals based on the connection test rule; and, when the third interference level information satisfies a third communication condition, determine that the first communication module and the second communication module are turned on by the aerial vehicle.

In one embodiment, when being configured to detect the third interference level information of the first communication link with the terminal device established through the third communication module at regular intervals based on the connection test rule, the process 701 may be configured to: periodically detect a plurality of interference level values of the first communication link with the terminal device established by the third communication module based on the periodic time information indicated by the connection test rule; and obtain the third interference level information according to the plurality of interference level values.

The present disclosure also provides a communication device. The communication device may be applied to an aerial vehicle or a terminal device.

In one embodiment, the communication device may be applied to an aerial vehicle. As shown in FIG. 8, the communication device 800 includes a communication module. The aerial vehicle may be able to establish at least two communication links with the terminal device based on the communication module. The at least two communication links may include a first communication link and a second communication link. The first communication link does not use the cellular network communication protocol, and the second communication link adopts the cellular network communication protocol. The communication device further includes: a processing unit 801 configured to obtain the downlink transmission data of the aerial vehicle; and a communication unit 802, configured to send the downlink transmission data to the terminal device through the first communication link.

The processing unit 801 may be further configured to determine the target data receiving mode from the plurality of data receiving modes. The plurality of data receiving modes may include a first data receiving mode and a second data receiving mode. The first data receiving mode may receive the uplink transmission data sent by the terminal device based on the first communication link, and the second data receiving mode may receive the uplink transmission data sent by the terminal device based on the first communication link and the second communication link.

The processing unit 801 may be further configured to control the communication module to work in the target data receiving mode, to receive the uplink transmission data sent by the terminal device. The uplink transmission data may include feedback data of the terminal device corresponding to the downlink transmission data and/or control data of the aerial vehicle by the terminal device.

In another embodiment, the communication device 800 may be applied to an aerial vehicle. The communication device 800 may transmit data with the terminal device based on a first communication module and a second communication module. The first communication module does not adopt the cellular network communication protocol, and the second communication module adopts the cellular network communication protocol.

The communication device 800 may further include a processing unit 801 and a communication unit 802. The processing unit 801 may be configured to obtain data collected by the aerial vehicle; send the collected data to the first communication module; process the collected data through the first communication module; and send first communication data obtained by processing to the terminal device.

The communication unit 802 may be configured to: receive the second communication data from the terminal device through the first communication module and receive the third communication data from the terminal device through the second communication module when the aerial vehicle presently turns on the first communication module and the second communication module.

Both the second communication data and the third communication data may be obtained and sent by the terminal device according to target data. The target data may be the control data of the aerial vehicle by the terminal device.

In another embodiment, the communication device 800 may be applied to a terminal device. The communication device 800 may include a communication module. The communication device 800 may be able to establish at least two communication links with the aerial vehicle through the communication module. The at least two communication links may include a first communication link and a second communication link. The first communication link does not use the cellular network communication protocol, and the second communication link adopts the cellular network communication protocol.

The communication device 800 may include: a processing unit 801 and a communication unit 802.

The communication unit 802 may be configured to receive the downlink transmission data sent by the aerial vehicle through the first communication link.

The processing unit 801 may be configured to: determine the target data transmission mode from the plurality of data transmission modes. The plurality of data transmission modes may include the first data transmission mode and the second data transmission mode. The first data transmission mode may send the uplink transmission data to the aerial vehicle based on the first communication link, and the second data transmission mode may send the uplink data to the aerial vehicle based on the first communication link and the second communication link.

The processing unit 801 may be further configured to control the communication module to work in the target data transmission mode to send the uplink transmission data to the aerial vehicle. The uplink transmission data may include the feedback data of the terminal device corresponding to the downlink transmission data and/or the control data of the aerial vehicle by the terminal device.

In another embodiment, the communication device 800 may be applied to a terminal device. The communication device 800 may transmit data with the aerial vehicle through the third communication module and the fourth communication module. The third communication module does not use the cellular network communication protocol, while the fourth communication module adopts the cellular network communication protocol.

The communication device 800 may include: a processing unit 801 and a communication unit 802.

The communication unit 802 may be configured to receive the first communication data sent by the aerial vehicle through the third communication module.

The processing unit 801 may be configured to: obtain the target data; when the aerial vehicle currently turns on the first communication module and the second communication module, process the target data through the third communication module to obtain the second communication data, and process the target data through the fourth communication module to obtain the third communication data.

The communication unit 802 may be further configured to: send the second communication data through the third communication module, and send the third communication data through the fourth communication module. The target data may be the control data of the aerial vehicle by the terminal device.

The present disclosure also provides a computer-readable storage medium. The computer-readable storage medium may be configured to store a computer program. When the computer program is executed by a processor, the communication method provided by various embodiments of the present disclosure may be implemented.

The computer-readable storage medium may be an internal storage unit of a terminal device described in any of the foregoing embodiments of the present disclosure, such as a hard disk or a memory of the terminal device. The computer-readable storage medium may also be an external storage device of the device, such as a plug-in hard disk equipped on the device, a smart memory card (SMC), a secure digital card (SD), or a flash card, etc. The computer-readable storage medium may also include both an internal storage unit of the terminal device and an external storage device. The computer-readable storage medium may be used to store a computer program or other programs and data required by a terminal device. The computer-readable storage medium can also be used to temporarily store data that has been output or will be output.

All or part of the process in the method of the above embodiments may be implemented through a computer program instructing related hardware. The program may be stored in a readable storage medium. When the program is executed, it may implement the above-mentioned method provided by various embodiments of the present disclosure. The storage medium may be a magnetic disk, an optical disk, a read-only memory (ROM) or a random access memory (RAM), and the like.

The terminology used in the present disclosure is for the purpose of describing particular embodiments only and is not intended to limit the scope of the present disclosure.

The term “and/or” used in the present disclosure and the appended claims refers to any combination of one or more of the associated listed items and all possible combinations, and includes these combinations.

The above are only specific implementations of embodiments of the present disclosure, but the scope of the present disclosure is not limited to this. One of ordinary skill in the art can easily think of various equivalents within the technical scope disclosed in the present disclosure. These modifications or replacements shall be included within the scope of the present disclosure. Therefore, the protection scope of the present invention shall be subject to the protection scope of the claims.

What is claimed is:

1. A communication method comprising:
obtaining downlink transmission data of an aerial vehicle, the aerial vehicle including a communication module based on which the aerial vehicle establishes at least two communication links with a terminal device, and the at least two communication links including a first communication link not adopting a cellular network communication protocol and a second communication link adopting the cellular network communication protocol;
sending the downlink transmission data to the terminal device based on the first communication link;
determining a target data receiving mode from a plurality of data receiving modes, the plurality of the data receiving mode including:
a first data receiving mode for receiving uplink transmission data sent by the terminal device based on the first communication link, the uplink transmission data including at least one of feedback data in response to the downlink transmission data or control data for controlling the aerial vehicle, and
a second data receiving mode for receiving the uplink transmission data based on the first communication link and the second communication link; and
controlling the communication module to work in the target data receiving mode, to receive the uplink transmission data.

2. The method according to claim 1, wherein the downlink transmission data includes at least one of:
data collected by the aerial vehicle, or
downlink transmission data of another aerial vehicle to be forwarded by the aerial vehicle.

3. The method according to claim 1, wherein the plurality of data receiving modes further includes a third data receiving mode for receiving the uplink transmission data based on the second communication link.

4. The method according to claim 3, wherein:
the aerial vehicle further includes a buffer configured to record sent downlink transmission data; and
a data volume of the sent downlink transmission data recorded in the buffer when the communication module works in the third data receiving mode is larger than a data volume of the sent downlink transmission data recorded in the buffer when the communication module works in the first data receiving mode or the second data receiving mode.

5. The method according to claim 4, wherein the data volume of the sent downlink transmission data recorded in the buffer when the communication module works in the third data receiving mode is determined based on a delay duration of the second communication link.

6. The method according to claim 1, wherein an enabling duration of the second communication link is longer than an enabling duration of the first communication link in the second data receiving mode.

7. The method according to claim 1, wherein in the second data receiving mode, the second communication link is kept enabled and the first communication link is enabled periodically.

8. The method according to claim 1, wherein:
receiving the control data includes receiving a data receiving mode selection instruction from the terminal device to the aerial vehicle, the data receiving mode selection instruction instructing the aerial vehicle to work in the target data receiving mode; and
determining the target data receiving mode from the plurality of data receiving modes includes determining the target data receiving mode from the plurality of data receiving modes based on the data receiving mode selection instruction.

9. The method according to claim 1, further comprising:
obtaining a communication quality of the first communication link;
wherein determining the target data receiving mode from the plurality of data receiving modes includes determining the target data receiving mode from the plurality of data receiving modes based on the communication quality of the first communication link.

10. The method according to claim 9, wherein obtaining the communication quality of the first communication link includes determining the communication quality of the first communication link based on the feedback data.

11. The method according to claim 1, wherein:
the plurality of data receiving modes further includes a third data receiving mode for receiving the uplink transmission data based on the second communication link; and
determining the target data receiving mode from the plurality of data receiving modes includes, in response to the communication module working in the first data receiving mode and a communication quality of the first communication link not satisfying a preset communication quality condition, switching a working mode of the communication module from the first data receiving mode to the second data receiving mode or the third data receiving mode.

12. A communication method comprising:
obtaining collected data collected by an aerial vehicle, the aerial vehicle being configured to communicate with a terminal device based on a first communication module not adopting a cellular network communication protocol and a second communication module adopting the cellular network communication protocol;
outputting the collected data to the first communication module, such that the first communication module processes the collected data to obtain first communication data and send the first communication data to the terminal device; and
in response to the first communication module and the second communication module being turned on, receiving second communication data based on the first communication module and receiving third communication data based on the second communication module;
wherein:
the second communication data and the third communication data are obtained and sent by the terminal device according to target data; and
the target data is control data of the terminal device for controlling the aerial vehicle.

13. The method according to claim 12, further comprising, before receiving the third communication data based on the second communication module:
in a process of the aerial vehicle communicating with the terminal device based on the first communication module, obtaining interference level information of the first communication link corresponding to the first communication module; and
in response to the interference level information satisfying a communication condition, turning on the second communication module to communicate with the terminal device through the second communication module.

14. The method according to claim 13,
wherein the interference level information is first interference level information;
the method further comprising, after turning on the second communication module:
obtaining second interference level information of the first communication link corresponding to the first communication module; and
in response to the second interference level information satisfying a default link communication condition, turning off the second communication module.

15. The method according to claim 12, further comprising:
in response to the aerial vehicle being in a low battery state and interference level information of the first communication link corresponding to the first communication module satisfying a communication condition, turning off the first communication module.

16. The method according to claim 15,
wherein the interference level information is a first interference level information and the communication condition is a first communication condition;
the method further comprising, after turning off the first communication module:
turning on the first communication module at regular intervals based on a connection test rule and detecting a second interference level information of the first communication link with the terminal device established through the first communication module after the first communication module is turned on; and
in response to the second interference level information satisfying a second communication condition, turning on the first communication module.

17. The method according to claim 16, wherein turning on the first communication module at the regular intervals and detecting the second interference level information after the first communication module is turned on include:
based on periodic time information indicated by the connection test rule, periodically turning on the first communication module to establish the first communication link with the terminal device through the first communication module;
performing interference evaluation on the first communication link to obtain a plurality of interference level values; and
obtaining the second interference level information according to the plurality of interference level values.

18. The method according to claim 12, further comprising:
after the second communication link between the aerial vehicle and the terminal device is established, increasing a receiving buffer, such that data received through the first communication module and data received through the second communication module are received in the increased receiving buffer.

19. An aerial vehicle comprising:
a communication module, based on which the aerial vehicle establishes at least two communication links with a terminal device, the at least two communication links including a first communication link not using a cellular network communication protocol and a second communication link adopting the cellular network communication protocol;
a power assembly configured to drive the aerial vehicle to move;
a memory storing a computer program; and
a controller is configured to execute the computer program to:
obtain downlink transmission data of the aerial vehicle;
send the downlink transmission data to the terminal device based on the first communication link device;
determine a target data reception mode from a plurality of data reception modes, the plurality of the data receiving mode including:
a first data receiving mode for receiving uplink transmission data sent by the terminal device based on the first communication link, the uplink transmission data including at least one of feedback data of the terminal device in response to the downlink transmission data or control data for controlling the aerial vehicle, and
a second data receiving mode for receiving the uplink transmission data based on the first communication link and the second communication link; and
control the communication module to work in the target data receiving mode to receive the uplink transmission data.

20. The aerial vehicle according to claim 19, wherein the plurality of data receiving modes further includes a third data receiving mode for receiving the uplink transmission data based on the second communication link.
